(19) United States
(12) Patent Application Publication
(10) Pub. No.: US 2013/0157666 A1
(43) Pub. Date: Jun. 20, 2013

(54) MOBILE COMMUNICATION TERMINAL APPARATUS, METHOD FOR CONTROLLING MOBILE COMMUNICATION TERMINAL APPARATUS, AND COMMUNICATION SYSTEM

(71) Applicant: Fujitsu Mobile Communications Limited, Kawasaki-shi (JP)

(72) Inventor: Makoto UCHINO, Hamura (JP)

(73) Assignee: FUJITSU MOBILE COMMUNICATIONS LIMITED, Kawasaki-shi (JP)

(21) Appl. No.: 13/664,262

(22) Filed: Oct. 30, 2012

(30) Foreign Application Priority Data
Dec. 15, 2011 (JP) 2011-274590

(51) Int. Cl. H04W 36/24

(52) U.S. Cl. 455/437

(57) ABSTRACT

An ETWSP receiving unit receives a primary message by use of an LTE network. An ETWSS receiving unit receives a secondary message by use of the LTE network. A 3G processing unit communicates by use of a 3G network. A CSFB control unit receives an instruction to switch to communication using the 3G network if connecting to the LTE network, switches connections from the LTE network to the 3G network if not having received the primary message, and holds the switching of the connection from the LTE network to the 3G network if having received the primary message and not having received the secondary message.

### CROSS-REFERENCE TO RELATED APPLICATION

This application is based upon and claims the benefit of priority of the prior Japanese Patent Application No. 2011-274590, filed on Dec. 15, 2011, the entire contents of which are incorporated herein by reference.

### FIELD

The embodiments discussed herein are directed to a mobile communication terminal apparatus, a method for controlling a mobile communication terminal apparatus, and a communication system.

### BACKGROUND

In recent years, LTE (Long Term Evolution) has been proposed as a next-generation high-speed wireless communications system (or a next-generation high-speed wireless communications system). LTE is a communication system that specializes in packet communication. Furthermore, as one of methods for realizing voice communication in LTE, VoIP (Voice over Internet Protocol) that handles voice over IP (Internet Protocol) is being discussed to be provided. However, UMTS (Universal Mobile Telecommunications System) and CDMA (Code Division Multiple Access) 2000 are currently used as voice communication. In such a mobile communications system having an existing circuit-switched network, it is difficult to maintain the continuity of communication between known voice communication and voice communication by VoIP, and a technical hurdle to the introduction of VoIP is still high. Moreover, in a mobile communication terminal apparatus that uses only a packet-switched network, it becomes impossible to use services offered only on the circuit-switched network.

It is assumed that a known wireless communications system for voice communication such as UMTS or CDMA2000 is used for voice communication by circuit switching. A communication network in the known wireless communications system for voice communication is hereinafter referred to as the “known communication network.” Specifically, it is assumed to use a system that performs voice communication after switching a communication network to connect to from the LTE network to a communication network for voice communication if receiving a voice call in a state where a mobile communication terminal apparatus exists in the LTE network. The system is called CSFB (Circuit Switched Fallback) if performed between any of mobile communications systems of the UMTS system, the GSM (Global System for Mobile communications) (registered trademark) system and the CDMA2000 system, and the LTE mobile communications system.

Methods for switching communication networks by CSFB are roughly divided into two. One is a method for switching by use of a function called redirection that opens a connection to the LTE network and notifies a connection request to a base station of the known communication network for reconnection. The other is a method for switching by use of a function called handover that detects a connectable base station of the known communication network in a state of connecting to the LTE network and switches connections to the detected base station.

Moreover, adopted in the LTE network is the ETWS (Earthquake and Tsunami Warning System) system that divides messages into a primary message and a secondary message to transmit when an emergency notification is made such as an earthquake and a tsunami. The primary message notifies minimum necessary information that is most urgent, such as the “occurrence of an earthquake.” The secondary message notifies supplemental information that is not conveyed by the primary message. ETWS realizes information distribution in the shortest time by sending a small-sized primary message including only minimum necessary information first.

In mobile communications systems such as the EPC (Evolved Packet Core) system and the E-UTRAN (Evolved Universal Terrestrial Radio Access) system, ETWS includes the following system. Included are CBC (Cell Broadcast Center) being a broadcast device connected to a CBS (Cell Broadcast Service) provider, MME (Mobility Management Entity) and a radio base station eNB (evolutional Node B). A message issued from the CBS provider is sent to MME via CBC. MME transmits the message to each eNB. A mobile communication terminal apparatus receives the message from an eNB existing within communication range of the apparatus itself.

In the transmission of the primary message, it is specified that an arrival time from MME to the mobile communication terminal apparatus is approximately 4 seconds.

The following technology is proposed as a technology for receiving emergency information by the mobile communication terminal apparatus. For example, a known technology that regulates handoff to another base station within the same communication network if the mobile communication terminal apparatus receives emergency information is proposed.
Patent Document 1: Japanese Laid-open Patent Publication No. 2010-246141

However, the mobile communication terminal apparatus switches a serving system by CSFB from LTE to the known communication network such as UMTS or CDMA2000 if receiving an incoming call immediately after receiving the primary message while existing in the LTE network. Even if communication networks are switched by redirection or handover, the connection between the mobile communication terminal apparatus and the LTE network is broken during and after the switching of the communication network. Therefore, in this case, the mobile communication terminal apparatus may be impossible to receive the secondary message.

Moreover, with the known technology that regulates handoff to another base station in the same communication network, if the mobile communication terminal apparatus receives emergency information, switching to another communication network is not assumed. Therefore, even if the known technology is used, it is not possible to handle switching from the LTE network to the known communication network for voice communication; accordingly, the secondary message may be similarly impossible to be received. Moreover, since only the regulation upon handoff is assumed, it is not possible to control switching upon redirection. Also from this point, it is difficult to handle switching from the LTE network to the known communication network for all voice communication.

### SUMMARY

According to an aspect of an embodiment, a mobile communication terminal apparatus includes: a first communication unit that receives first notification information and second notification information being additional information of the first notification information by use of a first communication network; a second communication unit that communicates by use of a second communication network; and a switching control unit that receives an instruction to switch to communication using the second communication network when connecting to the first communication network, switches connections from the first communication network to the second communication network when the first communication unit has not received the first notification information, and holds switching of a connection from the first communication network to the second communication network when the first communication unit has received the first notification information and has not received the second notification information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a configuration diagram of an entire communication system according to a first embodiment;

FIG. 2 is a block diagram of a mobile communication terminal apparatus according to the first embodiment;

FIG. 3 is a sequence diagram of a process of switching communication networks in a communication system according to the first embodiment;

FIG. 4 is a flowchart of a CSFB process in the mobile communication terminal apparatus according to the first embodiment; and

FIG. 5 is a hardware configuration diagram of the mobile communication terminal apparatus.

### DESCRIPTION OF EMBODIMENTS

Preferred embodiments of the present invention will be explained with reference to accompanying drawings. The following embodiments do not limit the mobile communication terminal apparatus, the method for controlling a mobile communication terminal apparatus, and the communication system, which are disclosed in the application.

### [a] First Embodiment

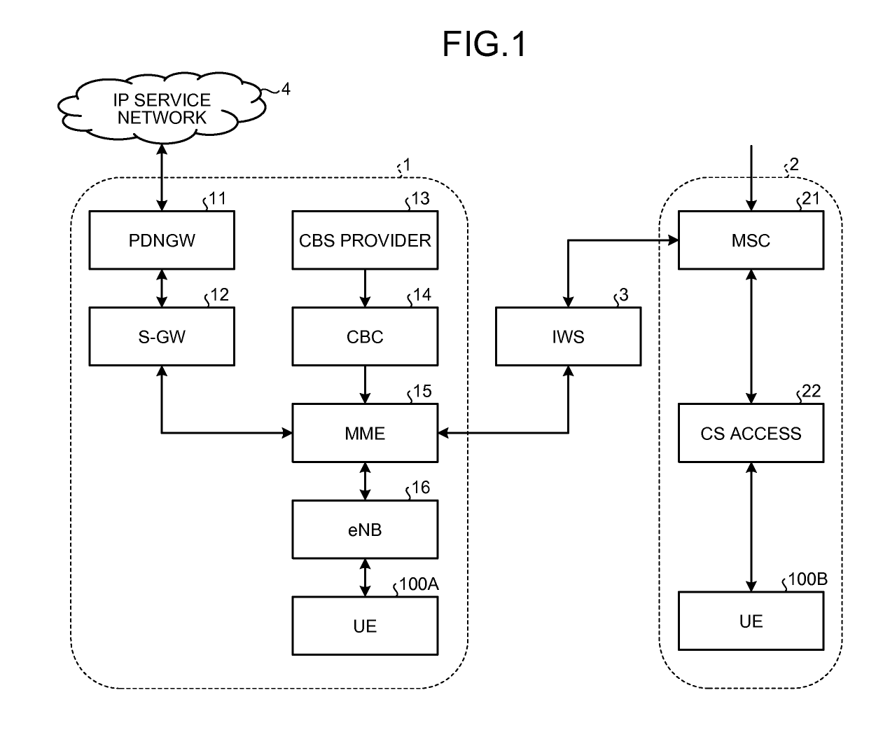

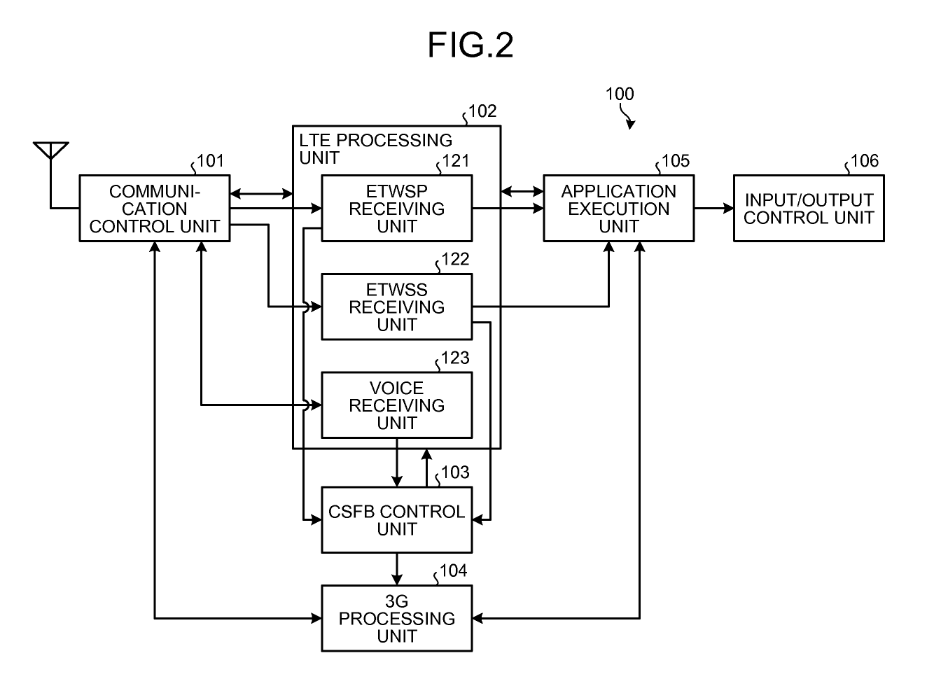

FIG. 1 is a configuration diagram of an entire communication system according to a first embodiment. FIG. 2 is a block diagram of a mobile communication terminal apparatus according to the first embodiment. In the following, a detailed description will be given of the mobile communication terminal apparatus with reference to FIG. 2 after a description is given of the entire configuration of the communication system including an LTE network and a 3G network with reference to FIG. 1.

As illustrated in FIG. 1, the communication system according to the embodiment includes an LTE network 1 and a 3G (3rd Generation) network 2. The LTE network 1 is a communication network that communicates in the LTE system (hereinafter referred to as the “LTE communication”). The LTE network 1 corresponds to an example of a “first communication network.” The 3G network 2 is a known communication network that communicates in systems such as CDMA2000 and UMTS. The 3G network 2 corresponds to an example of a “second communication network.”

The communication system according to the embodiment includes a PDNGW (Public Data Network Gateway) 11, an S-GW (Serving Gateway) 12, a CBS provider 13, a CBC 14, an MME 15, and an eNB 16 in the LTE network 1. Moreover, the communication system according to the embodiment includes an MSC (Mobile services Switching Center) 21 and a CS (Circuit Switch) Access 22 in the 3G network 2. The communication system according to the embodiment further includes an IWS (InterWorking Solution) 3 between the LTE network 1 and the 3G network 2. Moreover, in FIG. 1, the mobile communication terminal apparatus existing in the LTE network 1 is expressed as a UE (User Equipment) 100A. Furthermore, the mobile communication terminal apparatus existing in the 3G network 2 is expressed as a UE 100B. However, the UE 100A and the UE 100B are expressed in different numerals for convenience of the description, but can actually be the same mobile communication terminal apparatus. Although a case where one mobile communication terminal apparatus moves in the LTE network 1 and the 3G network 2 will be described below, the mobile communication terminal apparatus may be referred to as a UE 100 without distinguishing the serving communication networks in that case. To put another way, the UE 100 becomes the UE 100A if existing in the LTE network 1, and becomes the UE 100B if existing in the 3G network 2. The UE 100 may also be called a Mobile Station.

The PDNGW 11 is connected to an IP Service network 4 such as the Internet or an intranet. The PDNGW 11 is a gateway server for connecting to the Internet or an intranet. The PDNGW 11 receives a packet sent from another wireless communication terminal and the like from the IP Service network 4. The PDNGW 11 then outputs the received packet to the S-GW 12.

The S-GW 12 is a server that controls packet switching of LTE, and the like by use of a U-plane being a protocol hierarchy that handles user data. For example, the S-GW 12 performs a routing and a buffer process of a packet. The S-GW 12 receives from the PDNGW 11 the packet sent from another wireless communication terminal and the like. The S-GW 12 then outputs the received packet to the MME 15.

The CBS provider 13 is a provider of a service that broadcasts simple character information standardized in 3GPP (3rd Generation Partnership Project). The CBS provider 13 creates an emergency notification and outputs the created emergency notification to the CBC 14. For example, the CBS provider 13 outputs to the CBC 14 a request to distribute an ETWS primary message that notifies the occurrence of an earthquake immediately after the occurrence of the earthquake. The CBS provider 13 subsequently outputs to the CBC 14 a request to distribute an ETWS secondary message that notifies the information together with supplementary information such as the epicenter and the seismic intensity. Here, the primary message and the secondary message are transmitted, for example, by use of SMS (Short Message Service). The primary message corresponds to an example of “first notification information.” Moreover, the secondary message corresponds to an example of “second notification information.”

The CBC 14 is a server for broadcast. The CBC 14 receives from the CBS provider 13 the input of the request to distribute a primary message immediately after the occurrence of an earthquake. The CBC 14 then creates a primary message by use of information included in the distribution request. The CBC 14 subsequently outputs the created primary message to the MME 15. Next, the CBC 14 receives from the CBS provider 13 the input of the request to distribute a secondary message together with supplementary information such as the epicenter and the seismic intensity. The CBC 14 then creates a secondary message by use of the received information. The CBC 14 subsequently outputs the created secondary message to the MME 15.

The MME 15 is a server that performs the location management of the UE 100A in the LTE network 1, packet switching, a call to a base station apparatus upon incoming call, and the like by use of a C-plane being a protocol hierarchy that handles control.

The MME 15 receives the primary message from the CBC 14. The MME 15 then outputs the received primary message to the designated eNB 16. After receipt of the primary message, the MME 15 receives the secondary message from the CBC 14. The MME 15 then outputs the received secondary message to the designated eNB 16.

Moreover, the MME 15 receives the input of a call request from the IWS 3 if there is an incoming call in voice communication to the UE 100. The MME 15 then outputs the received call request to the eNB 16. The MME 15 subsequently receives from the eNB 16 the input of a call response as a response to the call request. The MME 15 then outputs the received call response to the IWS 3. Next, the MME 15 receives from the IWS 3 the input of a request to switch communication networks from the LTE network 1 to the 3G network 2. The MME 15 then outputs the request to switch communication networks to the eNB 16 that exists within the communication area of the UE 100A being a target of the switch request. The MME 15 then outputs to the IWS 3 a notification of communication rejection of the incoming call in voice communication as a response to the request to switch communication networks if receiving the notification of call rejection from the eNB 16.

Moreover, if the UE 100 exists in the LTE network 1, the MME 15 receives information on the location of the UE 100 from the eNB 16. The MME 15 then registers the information on the location of the UE 100, the information having been received from the eNB 16. Furthermore, the MME 15 outputs to the IWS 3 information on the UE 100 that has registered its location.

The eNB 16 is a base station of the LTE network 1, which performs call processing such as radio control and scheduling.

The eNB 16 receives the input of a primary message from the MME 15 if an earthquake occurs. The eNB 16 then broadcasts the received primary message to the UE 100A that exists within its communication area. After transmission of the primary message, the eNB 16 receives the input of a secondary message from the MME 15. The eNB 16 then broadcasts the received secondary message to the UE 100A that exists within its communication area.

Moreover, the eNB 16 receives the input of a call request from the MME 15 if there is an incoming call in voice communication to the UE 100. The eNB 16 then transmits the received call request to the UE 100. The eNB 16 subsequently receives from the UE 100 a call response that indicates the receipt of the call request. The eNB 16 then outputs the received call response to the MME 15. Next, the eNB 16 receives from the MME 15 the input of a CSFB request to the UE 100A being a target of the incoming call in voice communication. The eNB 16 transmits the received CSFB request to the designated UE 100A. If the incoming call is rejected in the UE 100A, the eNB 16 receives from the UE 100A a notification of call rejection as a response to the CSFB request. The eNB 16 then outputs to the MME 15 the received notification of call rejection.

The CBS provider 13, the CBC 14, the MME 15, the eNB 16, and the like correspond to examples of a “notification information transmission apparatus.”

The MSC 21 is a mobile switching center that controls the connection of a call in the 3 G communication network. The MSC 21 receives from the IWS 3 the input of the information on the UE 100A that has registered its location in the LTE network 1. The MSC 21 then stores the information on the UE 100A that exists in the LTE network 1.

The MSC 21 receives an incoming call in voice communication from another mobile communication terminal apparatus. The MSC 21 then determines, from the information on the UE 100A that exists in the LTE network 1, which of the LTE network 1 and the 3G network 2 the UE 100 being a target of the received incoming call in voice communication exists in. If the UE 100 being the target of the incoming call exists in the 3G network 2, the MSC 21 outputs the incoming call to the UE 100 to the CS Access 22.

On the other hand, if the UE 100 being the target of the incoming call exists in the LTE network 1, the MSC 21 outputs a call request to the IWS 3. The MSC 21 subsequently receives from the IWS 3 the input of a call response that indicates the receipt of the call request. Next, the MSC 21 outputs to the IWS 3 a CSFB request being a request to the UE 100 to implement the switching of the communication network from the LTE network 1 to the 3G network 2. The MSC 21 then receives the input of a notification of the completion of switching from the CS Access 22 or the input of a notification of call rejection from the IWS 3, as a response to the CSFB request. If receiving the notification of the completion of switching, the MSC 21 outputs the incoming call to the targeted UE 100 to the CS Access 22. On the other hand, if receiving the input of the notification of call rejection, the MSC 21 transmits the notification of call rejection to the mobile communication terminal apparatus that is the source of the request for voice communication.

If the connection in voice communication between the mobile communication terminal apparatus and the UE 100B is established, the MSC 21 relays voice data between the mobile communication terminal apparatus and the UE 100B.

If the communication networks are switched in the UE 100, the CS Access 22 receives the notification of the completion of switching from the UE 100. The CS Access 22 then outputs the notification of the completion of switching to the MSC 21.

Moreover, the CS Access 22 receives the input of the incoming call to the UE 100B from the MSC 21. The CS Access 22 then transmits the incoming call to the designated UE 100B. The CS Access 22 receives a response to the incoming call from the UE 100B. The CS Access 22 then outputs the response to the incoming call to the MSC 21.

If the connection in voice communication between the mobile communication terminal apparatus and the UE 100B is established, the CS Access 22 outputs the voice data received from the UE 100B to the MSC 21, and outputs the voice data received from the MSC 21 to the UE 100B. The CS Access 22 may also be called a Base Station (BS).

The MSC 21 and the CS Access 22 correspond to examples of a “communication apparatus.”

The IWS 3 is a switching center that connects the LTE network 1 and the 3G network 2. If the UE 100 exists in the LTE network 1, the IWS 3 receives from the MME 15 the input of the information on the UE 100A that has registered its location in the LTE network 1. The IWS 3 then outputs to the MSC 21 the information on the UE 100A that has registered its location in the LTE network 1.

Moreover, the IWS 3 receives the input of a call request from the MSC 21 if there is an incoming call in voice communication to the UE 100. The IWS 3 then outputs the received call request to the MME 15. The IWS 3 subsequently receives from the MME 15 a call response being a response to the call request. The IWS 3 then outputs the received call response to the MSC 21. Next, the IWS 3 receives the input of a CSFB request from the MSC 21. In response to the input of the CSFB request, the IWS 3 outputs to the MME 15 a switch request to switch communication networks to the 3G network 2. If the incoming call is subsequently rejected in the UE 100A, the IWS 3 receives a notification of call rejection as a response to the request to switch communication networks. The IWS 3 then outputs the received notification of call rejection to the MSC 21.

Next, a detailed description will be given of the UE 100 according to the embodiment with reference to FIG. 2. The UE 100 includes a communication control unit 101, an LTE processing unit 102, a CSFB control unit 103, a 3G processing unit 104, an application execution unit 105 and an input/output control unit 106.

If the UE 100 exists in the LTE network 1, the communication control unit 101 receives from the eNB 16 a packet sent from the IP Service network 4, and the like. The communication control unit 101 then converts the received packet to a base band signal to output to the LTE processing unit 102. Moreover, if receiving a primary message, the communication control unit 101 outputs the primary message to an ETWSP receiving unit 121. Moreover, if receiving a secondary message, the communication control unit 101 outputs the secondary message to an ETWSS receiving unit 122. Furthermore, if receiving a packet being a base band signal from the LTE processing unit 102, the communication control unit 101 converts the received packet to a wireless signal to transmit to the eNB 16.

Moreover, if there is an incoming call in voice communication in a state where the UE 100 exists in the LTE network 1, the communication control unit 101 receives a call request from the eNB 16. The communication control unit 101 then outputs the received call request to a voice receiving unit 123. The communication control unit 101 subsequently receives from the voice receiving unit 123 the input of a call response that indicates the receipt of the call request. The communication control unit 101 then transmits the received call response to the eNB 16.

Moreover, the input of a request to switch communication networks from the LTE network 1 to the 3G network 2 is received from the eNB 16. Here, the request to switch communication networks is, for example, a redirection message or a handoff command. The communication control unit 101 then outputs the received request to switch communication networks to the voice receiving unit 123. The communication control unit 101 subsequently receives from the voice receiving unit 123 the input of a notification of the completion of switching or the input of a notification of call rejection as a response to the request to switch communication networks. If receiving the input of the notification of implementation as a response to the switch request, the CSFB control unit 103 outputs the notification of the completion of switching to the CS Access 22. Moreover, if receiving the input of the notification of call rejection as a response to the switch request, the CSFB control unit 103 outputs the notification of call rejection to the MME 15.

Moreover, if the UE 100 exists in the 3G network 2, the communication control unit 101 receives call voice data in voice communication from the CS Access 22. The communication control unit 101 then converts the received voice data into a base band signal to output to the 3G processing unit 104. Moreover, after a voice communication connection is established, the communication control unit 101 outputs the voice data received from the CS Access 22 to the 3G processing unit 104, and transmits the voice data inputted from the 3G processing unit 104 to the CS Access 22.

The LTE processing unit 102 includes the ETWSP receiving unit 121, the ETWSS receiving unit 122, and the voice receiving unit 123.

The ETWSP receiving unit 121 receives the input of a primary message from the communication control unit 101. The ETWSP receiving unit 121 then notifies the receipt of the primary message to the CSFB control unit 103. Moreover, the ETWSP receiving unit 121 outputs the received primary message to the application execution unit 105.

The ETWSS receiving unit 122 receives the input of a secondary message from the communication control unit 101. The ETWSS receiving unit 122 then notifies the receipt of the secondary message to the CSFB control unit 103. Moreover, the ETWSS receiving unit 122 outputs the received secondary message to the application execution unit 105.

The voice receiving unit 123 receives a call request from the eNB 16 via the communication control unit 101. The voice receiving unit 123 then transmits a call response to notify the receipt of the call request to the eNB 16 via the communication control unit 101.

The voice receiving unit 123 receives the input of a request to switch communication networks from the communication control unit 101. The voice receiving unit 123 then outputs the request to switch communication networks to the CSFB control unit 103. The voice receiving unit 123 receives from the CSFB control unit 103 the input of a notification of the completion of switching or a notification of call rejection, as a response to the request to switch communication networks. The voice receiving unit 123 then outputs to the communication control unit 101 the received notification of the completion of switching or notification of call rejection.

Moreover, if receiving a request to execute a process of switching communication networks from the CSFB control unit 103, the LTE processing unit 102 implements the process of switching communication networks.

Furthermore, the LTE processing unit 102 receives from the communication control unit 101 a packet converted into a base band signal and sent from the IP Service network 4, and the like. The LTE processing unit 102 then performs a decoding process and the like on the received packet. The LTE processing unit 102 subsequently outputs the packet on which the decoding process and the like have been performed to the application execution unit 105. Moreover, the LTE processing unit 102 receives from the application execution unit 105 the input of a packet of data to transmit to another mobile communication terminal apparatus and the like. The LTE processing unit 102 then performs a coding process and the like on the packet received from the application execution unit 105. The LTE processing unit 102 subsequently outputs the packet on which the coding process and the like have been performed to the communication control unit 101. The LTE processing unit 102 corresponds to an example of a “first communication unit.”

The CSFB control unit 103 includes a timer. The CSFB control unit 103 receives the input of the primary message from the ETWSP receiving unit 121. If receiving the primary message, the CSFB control unit 103 starts measuring time with its own timer and measures the time up to a preset time limit T. Here, the time limit T is set such that the time from the MSC 21's transmission of a CSFB request to receipt of a notification of the completion of CSFB is within a time specified as the time limit (hereinafter referred to as Timer A). In the embodiment, for example, a total of the time from the MSC 21's output of a CSFB request to the UE 100's receipt of a switch request and the time from the UE 100's output of a notification of the completion of switching to the MSC 21's receipt of a notification of the completion of CSFB is obtained, and a value obtained by subtracting the time obtained from Timer A is set as the time limit T. The time limit T corresponds to a “predetermined period.”

Moreover, the CSFB control unit 103 receives the input of the secondary message from the ETWSS receiving unit 122.

Moreover, the CSFB control unit 103 receives the notification of the receipt of the request to switch communication networks from the voice receiving unit 123. At the time of receiving the notification of the receipt of the request to switch communication networks, the CSFB control unit 103 determines whether to have received the primary message or the secondary message.

If having received no message or both messages, the CSFB control unit 103 causes the LTE processing unit 102 and the 3G processing unit 104 to perform the following process of switching communication networks in accordance with the switch request. For example, if a handoff command is used as the switch request, the CSFB control unit 103 causes the 3G processing unit 104 to detect the CS Access 22 that can communicate with. The CSFB control unit 103 then causes the LTE processing unit 102 and the 3G processing unit 104 to implement a process of handover to the CS Access 22, the process having been detected from the connected eNB 16. The CSFB control unit 103 subsequently causes the 3G processing unit 104 to transmit the notification of the completion of switching. Moreover, for example, if a redirection message is used as the switch request, the CSFB control unit 103 causes the LTE processing unit 102 to notify the eNB 16 of the release of a connection to the LTE network 1 and release the connection to the LTE network 1. The CSFB control unit 103 subsequently causes the 3G processing unit 104 to transmit a connection request to the CS Access 22 and establish a connection to the 3G network 2. The CSFB control unit 103 subsequently causes the 3G processing unit 104 to transmit the notification of the completion of switching.

If having received the primary message and not having received the secondary message, the CSFB control unit 103 holds the process of switching communication networks unless the time measured by its own timer exceeds the time limit T. The CSFB control unit 103 subsequently maintains the state of waiting for the receipt of the secondary message until the measured time exceeds the time limit T. If receiving the secondary message during the time limit T, the CSFB control unit 103 performs the process of switching communication networks in accordance with a similar switch request to that of when having received no message. Moreover, if not receiving the secondary message until the time limit T elapses, the CSFB control unit 103 outputs the notification of call rejection to the voice receiving unit 123. The CSFB control unit 103 corresponds to an example of a “switching control unit.”

The 3G processing unit 104 receives from the communication control unit 101 voice data from another wireless communication terminal apparatus, the voice data having been converted into a base band signal. The 3G processing unit 104 then performs a decoding process and the like on the received voice data. The 3G processing unit 104 subsequently outputs the voice data on which the decoding process and the like have been performed to the application execution unit 105. Moreover, the LTE processing unit 102 receives from the application execution unit 105 the input of voice data to transmit to another mobile communication terminal apparatus and the like. The LTE processing unit 102 then performs a coding process and the like on the voice data received from the application execution unit 105. The LTE processing unit 102 subsequently outputs the voice data on which the coding process and the like have been performed to the communication control unit 101. Here, in the embodiment, the communication by use of the 3G network 2 has been described taking an example of voice communication, but not limited to this, and the 3G processing unit 104 may perform data communication in another format.

Moreover, if receiving a request to execute the process of switching communication networks from the CSFB control unit 103, the 3G processing unit 104 implements the process of switching communication networks. The 3G processing unit 104 subsequently receives an instruction to transmit the notification of the completion of switching from the CSFB control unit 103. The 3G processing unit 104 then transmits the notification of the completion of switching to the CS Access 22 via the communication control unit 101. The 3G processing unit 104 corresponds to an example of a “second communication unit.”

The application execution unit 105 receives the input of a packet from the LTE processing unit 102. The application execution unit 105 then executes a corresponding application by use of the received packet to output the execution result and the like to the input/output control unit 106. For example, the application execution unit 105 receives the input of a primary message from the ETWSP receiving unit 121. The application execution unit 105 then creates a primary message display screen from the primary message by use of a predetermined display format, and outputs to the input/output control unit 106 the created primary message display screen together with a display instruction. Moreover, for example, the application execution unit 105 receives the input of a secondary message from the ETWSS receiving unit 122. The application execution unit 105 then creates a secondary message display screen from the secondary message by use of a predetermined display format, and outputs to the input/output control unit 106 the created secondary message display screen together with a display instruction.

Moreover, the application execution unit 105 receives the input of the voice data from the 3G processing unit 104. The application execution unit 105 then instructs the input/output control unit 106 to output the received voice data.

Moreover, the application execution unit 105 receives input data from an operator from the input/output control unit 106. The application execution unit 105 then executes an application corresponding to the input data. If packet communication is requested upon execution of the application, the application execution unit 105 creates a packet to transmit and outputs the created packet to the LTE processing unit 102. Moreover, if voice communication is performed, the application execution unit 105 outputs the voice data inputted from the operator to the 3G processing unit 104.

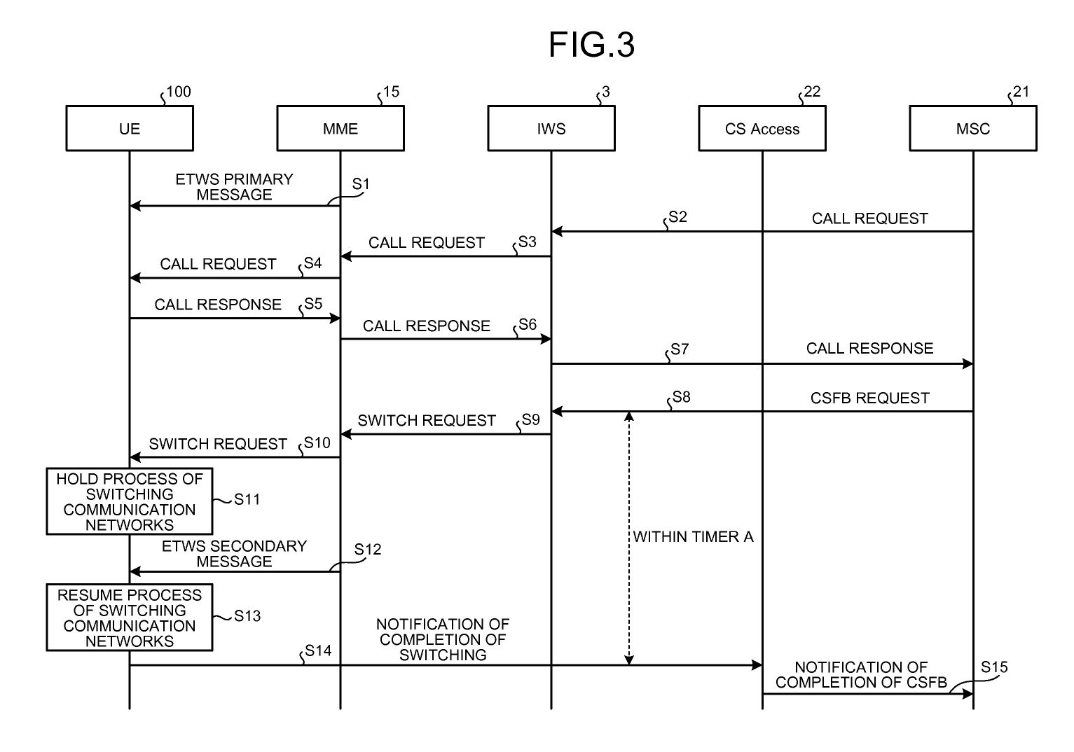

Next, a description will be given of the flow of a process of when the primary message has been received upon receipt of the request to switch communication networks in the communication system according to the embodiment with reference to FIG. 3. FIG. 3 is a sequence diagram of the process of switching communication networks in the communication system according to the first embodiment. FIG. 3 illustrates the passage of time along longitudinal axes extending from the devices. A process illustrated on the longitudinal axis extending from each device represents a process to be executed by each device at that point. Moreover, the arrows connecting the intervals between the longitudinal axes extending from the devices represent the flow of data. Moreover, for convenience of description, in FIG. 3, the upstream devices than the MME 15 in the notification of emergency information are omitted. Furthermore, for convenience of description, in FIG. 3, the eNB 16 is omitted. The eNB 16 actually relays the transmission and receipt of data between the MME 15 and the UE 100. Moreover, the UE 100 exists in the LTE network 1 in a state where the sequence illustrated in FIG. 3 starts.

The MME 15 transmits an ETWS primary message to the UE 100 (Step S1).

The MSC 21 transmits a call request to the IWS 3 before the MME 15 transmits an ETWS secondary message (Step S2). The IWS 3 transmits the call request received from the MSC 21 to the MME 15 (Step S3). The MME 15 transmits the call request received from the IWS 3 to the UE 100 (Step S4).

If receiving the call request, the UE 100 outputs to the MME 15 a call response to notify the receipt of the call request (Step S5). The MME 15 transmits the call response received from the UE 100 to the IWS 3 (Step S6). The IWS 3 transmits to the MSC 21 the call response received from the MME 15 (Step S7).

If receiving the call response, the MSC 21 checks that the UE 100 exists in the LTE network 1 and transmits a CSFB request to the IWS 3 (Step S8). If receiving the CSFB request, the IWS 3 transmits a request to switch communication networks to the MME 15 (Step S9). The MME 15 transmits to the UE 100 the request to switch communication networks received from the IWS 3 (Step S10).

If receiving the request to switch communication networks, the UE 100 checks whether to have received the ETWS primary message. Here, the ETWS primary message has been received. In this case, the UE 100 holds the process of switching communication networks from the LTE network 1 to the 3G network 2 in accordance with the request to switch communication networks (Step S11). The UE 100 then waits for arrival of the ETWS secondary message.

The UE 100 receives the ETWS secondary message from the MME 15 (Step S12).

If receiving the ETWS secondary message, the UE 100 resumes the process of switching communication networks from the LTE network 1 to the 3G network 2 in accordance with the request to switch communication networks (Step S13).

If completing switching communication networks, the UE 100 transmits a notification of the completion of switching to the CS Access 22 (Step S14). At this point, the time from the transmission of a CSFB request from the MSC 21 to the transmission of a notification of the completion of switching to the CS Access 22 is within Timer A. If receiving the notification of the completion of switching from the UE 100, the CS Access 22 transmits the notification of the completion of CSFB to the MSC 21 (Step S15).

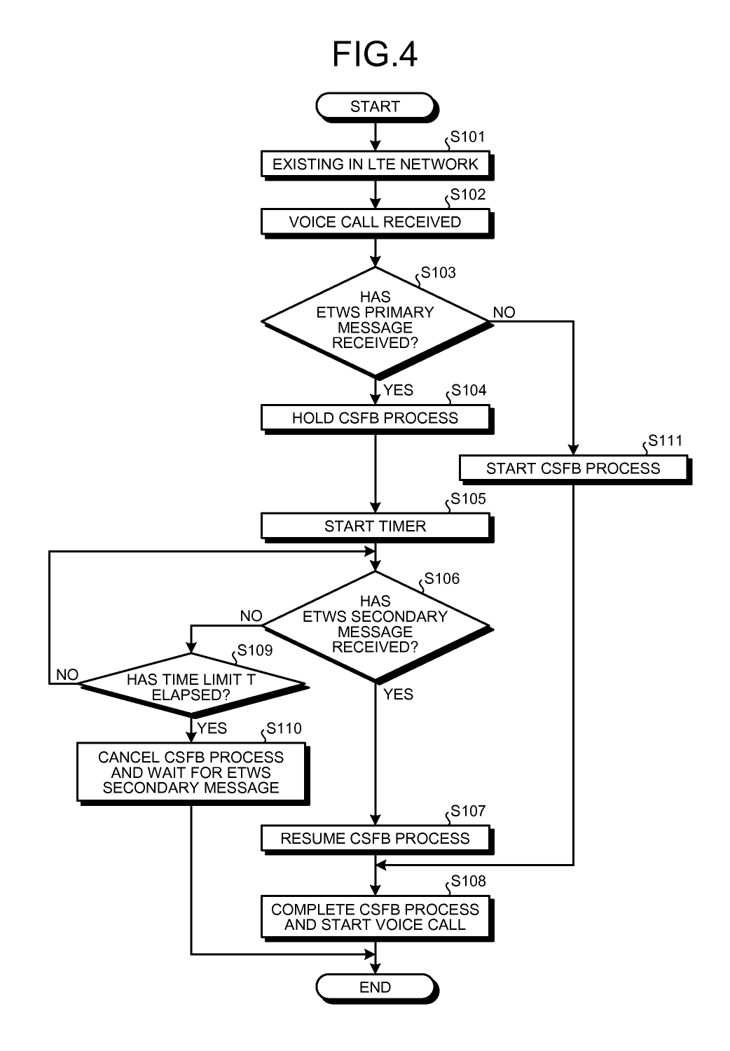

Next, a description will be given of the flow of a CSFB process in the mobile communication terminal apparatus according to the embodiment with reference to FIG. 4. FIG. 4 is a flowchart of the CSFB process in the mobile communication terminal apparatus according to the first embodiment.

The UE 100 exists in the LTE network 1 (Step S101).

The voice receiving unit 123 receives a voice call (Step S102).

The CSFB control unit 103 receives the input of the notification of the receipt of the voice call from the voice receiving unit 123. The CSFB control unit 103 then determines whether or not the ETWSP receiving unit 121 has received the ETWS primary message (Step S103). If the ETWSP receiving unit 121 has not received the primary message (Step S103: negative), the CSFB control unit 103 starts the CSFB process (Step S111). If the CSFB process by the CSFB control unit 103 is subsequently complete, the UE 100 starts a voice call (Step S108).

On the other hand, if the ETWSP receiving unit 121 has received the primary message (Step S103: positive), the CSFB control unit 103 holds the CSFB process that is the process of switching communication networks from the serving LTE network 1 to the 3G network 2 (Step S104). The CSFB control unit 103 then starts the timer and measures the time limit T (Step S105).

The CSFB control unit 103 subsequently determines whether or not the ETWSS receiving unit 122 has received the ETWS secondary message (Step S106). If the ETWSS receiving unit 122 has received the secondary message (Step S106: positive), the CSFB control unit 103 resumes the CSFB process (Step S107). If the CSFB process by the CSFB control unit 103 is subsequently complete, the UE 100 starts a voice call (Step S108).

On the other hand, if the ETWSS receiving unit 122 has not received the secondary message (Step S106: negative), the CSFB control unit 103 determines whether or not the time limit T has elapsed (Step S109). If the time limit T has not elapsed (Step S109: negative), the CSFB control unit 103 returns to Step S106, and waits for the secondary message until the time limit T elapses.

On the other hand, if the time limit T has elapsed (Step S109: positive), the CSFB control unit 103 outputs the notification of call rejection to the voice receiving unit 123 to cancel the CSFB process, and waits until the receipt of the ETWS secondary message (Step S110).

As described above, the mobile communication terminal apparatus according to the embodiment waits for the secondary message without switching to the 3G network unless receiving the secondary message even if receiving a voice call in a state of existing in the LTE network and having received the ETWS primary message. Therefore, the mobile communication terminal apparatus according to the embodiment can improve the reliability of receipt of the secondary message.

Moreover, for example, in the method that regulates a handover destination upon receipt of emergency information, it is difficult to handle the switching of the communication network by redirection. On the other hand, with the mobile communication terminal apparatus according to the embodiment, it is possible to suppress the switching of the communication network, even if any method of handover and redirection is used as the switching of the communication network, as long as in a state of waiting for the receipt of the secondary message. Therefore, with the mobile communication terminal apparatus according to the embodiment, it is possible to receive the secondary message more securely.

### [b] Second Embodiment

Next, a description will be given of a second embodiment. A mobile communication terminal apparatus according to the embodiment is different from that of the first embodiment in a point that if exceeding the time limit T of wait for the receipt of the secondary message, a voice call prevails. Hence, a description will be given below mainly of the operation after the excess of the time limit T. The block diagram of the mobile communication terminal apparatus according to the embodiment is also illustrated in FIG. 2. The units including the same reference numerals as those of the first embodiment are assumed to have the same functions unless otherwise described.

If the ETWSP receiving unit 121 has already received the primary message at the time of receiving the request to switch communication networks from the voice receiving unit 123, the CSFB control unit 103 starts the timer. The CSFB control unit 103 then holds the switching of the communication network and waits for the receipt of the secondary message until the excess of the time limit T.

If the ETWSS receiving unit 122 has not received the secondary message at the time of the excess of the time limit T, the CSFB control unit 103 starts the switching of the communication network from the serving LTE network 1 to the 3G network 2. If the switching of the communication network is complete, the CSFB control unit 103 outputs to the voice receiving unit 123 the notification of the completion of switching. A voice communication is subsequently established between the UE 100 and the transmission source of the incoming call in voice communication, a user performs voice communication by use of the UE 100.

As described above, the mobile communication terminal apparatus according to the embodiment switches communication networks to the 3G network and executes a voice call unless the secondary message arrives within the time limit. Therefore, it is possible to securely perform voice communication after waiting for the receipt of the secondary message until the limit that can continue the voice communication. In other words, it is possible to balance between the receipt of the secondary message and the continuation of voice communication.

Hardware Configuration

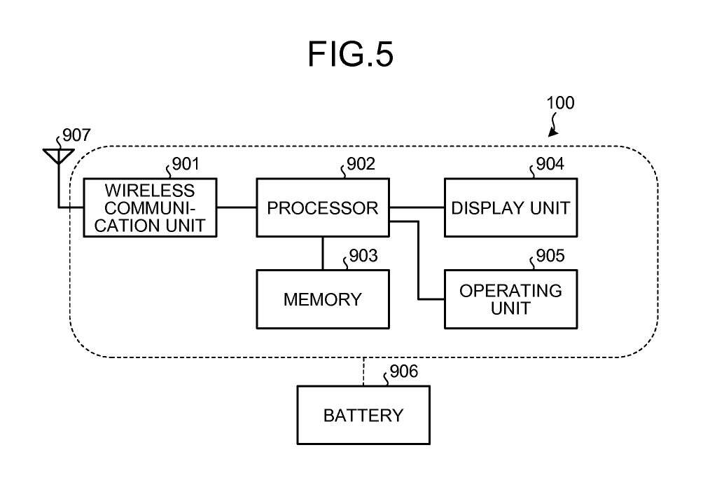

Next, a description will be given of a hardware configuration of the mobile communication terminal apparatuses according to the embodiments with reference to FIG. 5. FIG. 5 is a hardware configuration diagram of the mobile communication terminal apparatus.

As illustrated in FIG. 5, the UE 100 being the mobile communication terminal apparatus according to the embodiments include a wireless communication unit 901, a processor 902, a memory 903, a display unit 904, an operating unit 905, a battery 906 and an antenna 907.

The battery 906 supplies power to the units encircled by a dotted line.

The wireless communication unit 901, the memory 903, the display unit 904 and the operating unit 905 are each connected by a bus to the processor 902.

The wireless communication unit 901 is connected to the antenna 907. The wireless communication unit 901 realizes the function of the communication control unit 101 illustrated in FIG. 2, for example.

The display unit 904 is a display device such as a liquid crystal screen. Moreover, the operating unit 905 is an input device such as a keypad. The display unit 904, the operating unit 905 and the processor 902 realize the functions of the input/output control unit 106 in FIG. 2, for example.

The processor 902 and the memory 903 realize the functions of the LTE processing unit 102, the CSFB control unit 103, the 3G processing unit 104 and the application execution unit 105, which are illustrated in FIG. 2, for example. For example, the memory 903 stores various programs that realize the processes by the LTE processing unit 102, the CSFB control unit 103, the 3G processing unit 104, the application execution unit 105, and the like, which are illustrated in FIG. 2. The processor 902 and the memory 903 then read and execute these various programs to create the processes that realize the above-mentioned functions.

An aspect of a mobile communication terminal apparatus, a method for controlling a mobile communication terminal apparatus, and a communication system, which are disclosed in the application, takes effect that can improve the reliability of receipt of secondary information being additional information of primary information upon emergency notification.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A mobile communication terminal apparatus comprising:
a first communication unit that receives first notification information and second notification information being additional information of the first notification information by use of a first communication network;
a second communication unit that communicates by use of a second communication network; and
a switching control unit that receives an instruction to switch to communication using the second communication network when connecting to the first communication network, switches connections from the first communication network to the second communication network when the first communication unit has not received the first notification information, and holds switching of a connection from the first communication network to the second communication network when the first communication unit has received the first notification information and has not received the second notification information.

2. The mobile communication terminal apparatus according to claim 1, wherein the switching control unit starts the switching of the connection from the first communication network to the second communication network when the first communication unit receives the second notification information in a state of holding the switching of the connection from the first communication network to the second communication network.

3. The mobile communication terminal apparatus according to claim 1, wherein the switching control unit notifies a rejection of the switch instruction to a transmission source of the switch instruction when the first communication unit does not receive the second notification information within a predetermined period after receipt of the switch instruction.

4. The mobile communication terminal apparatus according to claim 1, wherein the switching control unit starts the switching of the connection from the first communication network to the second communication network when the second communication unit does not receive the second notification information within a predetermined period after receipt of the switch instruction.

5. A method for controlling a mobile communication terminal apparatus, the method comprising:
determining whether to have received first notification information when receiving an instruction to switch to communication using a second communication network in a state of connecting to a first communication network from which the first notification information and second notification information being additional information of the first notification information are received;
executing switching of a connection from the first communication network to the second communication network and communicating by use of the second communication network when not having received the first notification information; and
continuing wait for receipt of the second notification information without switching connections from the first communication network to the second communication network when having received the first notification information and not having received the second notification information.

6. A communication system comprising:
a first communication system;
a second communication system; and
a mobile communication terminal apparatus, wherein
the first communication system includes a notification information transmission apparatus that transmits to the mobile communication terminal apparatus first notification information and second notification information being additional information of the first notification information, by use of a first communication network,
the second communication system includes a communication apparatus that communicates with the mobile communication terminal apparatus by use of a second communication network,
the mobile communication terminal apparatus includes
a first communication unit that receives the first notification information and the second notification information, which are transmitted from the notification information transmission apparatus by use of the first communication network,
a second communication unit that communicates with the communication apparatus by use of the second communication network,
a switching control unit that receives an instruction to switch to communication using the second communication network when connecting to the first communication network, switches connections from the first communication network to the second communication network when the first communication unit has not received the first notification information, and holds switching of a connection from the first communication network to the second communication network when the first communication unit has received the first notification information and has not received the second notification information.
